(19) United States
(12) Patent Application Publication
(10) Pub. No.: US 2002/0174051 A1
(43) Pub. Date: Nov. 21, 2002

(54) Matching system

(76) Inventor: Daniel Wise, Fairfield, CA (US)

Correspondence Address: SYNNESTVEDT & LECHNER LLP, Aramark Tower, 1101 Market Street, Suite 2600, Philadelphia, PA, 19107, US

(21) Appl. No.: 09/855,269

(22) Filed: May 15, 2001

(51) Int. Cl. G06F 17/60

(52) U.S. Cl. 705/37

(57) ABSTRACT

A method and system for matching a buyer of goods with a seller of goods. The seller lists its goods for sale on the system by way of the Internet. The seller classifies the goods two ways. First, the goods are classified in accordance with their characteristics and second, in accordance with the criteria for acceptable buyers of the goods. To access the system a buyer must register for access. The registration process requires the buyer to submit, by way of the Internet, information regarding the buyer's identity and business operations. The system independently verifies the information submitted by the buyer and provides for the assessment of its veracity. Upon the verification of the information, the buyer is either granted or denied access to the system. Buyers granted access are able to query the system in relation to the characteristics of the goods listed thereon. All goods which match the buyer's query will be filtered based on the identity of the buyer and the buyer criteria associated with the goods. Those goods which match the buyer's query and for which the buyer satisfies the buyer criteria associated with such goods will be displayed to the buyer as available for purchase.

### FIELD OF THE INVENTION

The present invention relates to methods and systems for matching a buyer of goods with a seller of goods.

### Background of the Invention

Most manufacturers and other sellers of consumer products generate surplus goods on an increasing scale as they are under constant pressure to for growth. Businesses create surplus goods in the ordinary course of business as a result of manufacturer overruns, the discontinuation of products, customer returns, retail overstocks, the introduction of new lines of merchandise, license expirations, and evolving market preferences. Surplus goods can adversely affect an organization's financial performance by tying up capital that could otherwise be invested more productively. In addition, businesses incur costs associated with storing, tracking and maintaining surplus goods. It is estimated that the market for surplus goods totaled more than $400 billion worldwide in 1999. Approximately 30% of such is believed to be related to consumer goods.

The surplus goods industry operates through brokers, liquidators and other such intermediaries. These intermediaries act as agents for sellers and find buyers for their surplus goods. Trust between the intermediary and the seller is key for the surplus industry to function. However, it is this very key that constricts the development of the surplus goods industry.

There are a number of difficulties with the current surplus goods market. The surplus goods market is highly fragmented. This leads to inefficiencies in selling surplus goods. There are limited comprehensive sources of information about the availability of surplus goods. Buyers and sellers are widely dispersed. Sellers have difficulty locating buyers of their goods or have limited access to intermediaries. As well, buyers may not have established relationships with these intermediaries and, as such, may not have sources for the goods they need.

Sellers do not want to jeopardize their retail sales. Manufacturers are often the largest sellers of surplus goods. However, manufacturers, at all times, must maintain the separation between their retail distribution channels and the surplus goods market to avoid the occurrence of “channel conflict”.

Channel conflict results when retail and surplus goods buyers are selling the same good, to the same market, at the same time, but for different prices, retail and discount. Upon the occurrence of channel conflict the retail buyer generally demands the manufacturer to reimburse the retail buyer for the additional costs of the goods purchased at retail pricing. The result to the manufacturer is that it has jeopardized its relationship with its highest margin purchasers, the retail buyers. To ensure their continued relationship with the retail buyers the manufacturer often refunds the difference between the retail and surplus prices for the goods. As a result the manufacturer looses most, if not all, of its profit margin on the sold goods. It is often the safer course of conduct for the manufacturer to destroy surplus goods and take a loss rather then risk the possibility of channel conflict.

To avoid channel conflict or even the perception of it, it is the current practice for manufacturers to use intermediaries to sell their goods. The function of intermediaries is to maintain the anonymity of the seller, ensure that only bona fide surplus buyers are purchasing the surplus goods and that the goods are being sold in different markets than the markets the retailers are selling the goods in.

By avoiding channel conflict, trust in the integrity of the surplus goods marketplace is maintained for the buyers and sellers. Retail buyers are not threatened by competitors buying the same goods at surplus prices, sellers are able to maximize their margin on their goods by selling to retail customers at retail prices and surplus buyers have the opportunity to access quality seller surplus goods.

However, the problem with addressing channel conflict in this manner is that it is based on established relationships between the seller and the intermediary. It takes a significant amount of time to build trust in such relationships and as a result, few are established. In turn, the intermediary needs to establish trusting relationships with surplus buyers, which also takes significant time and as a result few are established. As such, surplus buyers have limited access to limited intermediaries and correspondingly limited amounts of surplus goods. In industries where seller have not established such relationships, surplus buyers have no access to surplus goods. Access to surplus goods is a critical problem for the surplus goods market since it is the commodity of their industry.

In addition to the problems of channel conflict and access to surplus goods, the traditional surplus market also has a problem with the speed at which it can acquire and liquidate goods. To maximize the liquidation value of surplus goods the goods must be processed between the retail and surplus markets as quickly as possible. Goods that are sold in the surplus market often have a much more limited market cycle before they are considered valueless. The problems of market fragmentation, channel conflict and access to surplus goods all create delays in the processing of surplus goods and as such both sellers and buyers miss potential opportunities to capture greater revenue.

With the advances in computers and communications a number of systems have been developed to match buyers with sellers of goods. Many of these systems are applicable to the surplus goods market and can address a number of its difficulties. For example, U.S. Pat. No. 5,940,807 describes a restrictive access seller and buyer system that is managed by a host operating system. The operating system has data relating to the seller's goods and may be used as a filter of the goods for compiling a list of total available merchandise for the member buyers based on criteria the buyers have inputted. Further, the host is able to filter any searches performed by buyers relating to the buyer's identity and criteria established by the seller relating to which buyers are acceptable to purchase the seller's goods. However, the system relies on the veracity of the information inputted by the buyer and does not independently verify such information. As such, non-bona fide surplus buyers may be able to fraudulent gain access to the system and thereby erode the integrity of the system in managing channel conflict. This may not be a significant problem for most buyers and sellers engaged in regular commerce markets, however, as discussed, this is a key problem for the surplus market.

The following inventions present methods similar to U.S. Pat. No. 5,940,807 for the matching of buyers with sellers of goods, however they also all suffer from the same deficiency when applied to the surplus market.

U.S Pat. No. 5,842,178 and U.S. Pat. No. 5,758,328 describe a computerized system forming a restricted network of buyers and/or seller for processing requests for goods and services quotes, including surplus goods, through a host. The buyer's request for goods or services is broadcast through the host to perspective sellers based on filter conditions set by the buyer and/or the seller and/or the host operator. The seller is able to selective respond to such requests and provide a quote relating thereto.

U.S. Pat. No. 5,664,115 describes a method of automatically matching sellers' property with potential buyers through a host system. A database of the available properties are held on the host system and may be searched by a potential buyer. The system permits the automatic evaluation of potential buyers to screen buyers whose information does not match minimum criteria provided by the seller. The system provides a means for selectively displaying property listings to potential buyers and for obtaining buyers' profile information associated therewith which is provided to sellers of the property. The system compares the buyer qualification information with a threshold value stored in association with the property record and if the buyer's qualifications exceed those thresholds, the system creates a buyer record and associates that with the property records requested and forwards same to the seller of the properties for consideration.

U.S. Pat. No. 5,924,802 describes a system for matching transactions between counterparties based on each party's trading and ranking information in relation to the other system users. Once the parties are matched, the system enables the parties to negotiate and finalize the terms of the transaction. The system attempts to match bids and offers entered by the users based on the ranking information entered by the users.

U.S. Pat. No. 5,592,375 describes a system for brokering transactions between sellers and buyers of goods or services including a database which lists sellers' goods. The system permits the seller to enter descriptive information including profile vectors into the said database regarding the seller itself. The buyer is able to search the database in accordance with the descriptive terms entered including the profile vectors.

These and other known matching systems as applied to the surplus goods market have addressed some of its difficulties, particularly the problems of the fragmented market place and speed to market. These systems have addressed these problems by utilizing databases and global communication networks such as the Internet, to create easily accessible indexed catalogues of available seller goods and provided a means for buyers to search such catalogues. To avoid channel conflict or other such undesirable sales, the more sophisticated systems have implemented means for the seller to establish restrictions on what buyers may purchase the seller's goods.

However, the transition from a system wherein the buyer and seller dealt directly or by way of intermediaries, to an electronic system that does not have a such “live” interaction or intermediaries has created a new type of problem which the existing matching systems do not address, namely, imposters.

The deficiency of the prior art systems is that none of them go beyond collecting the registration data for a buyer account. They do not validate or investigate all registration data to verify if the buyer is in fact who they represent to be; that the buyer is not operating behind a front or is an imposter. As such, a deceptive retail buyer is able to enter into their system based on false credentials and collect sensitive data relating to how the goods they normally carry are listed on the surplus goods system. Information which the retail buyer will likely use to either purchase the goods by way of the system at a discount or to force the manufacturer to offer them a discounted price for their retail purchases. Such deceptive retail buyers, if allowed to enter a surplus goods system can quickly destroy the sellers confidence in the system. Lack of seller confidence will destroy a surplus goods system.

There is therefore a need for a system that verifies the identities of buyers in order that sellers can list their surplus goods without fear of the jeopardizing their relationships with retail buyers.

### Summary of the Invention

The invention provides a method for matching a seller of goods with a buyer of goods who satisfies the seller's criteria. The method includes a step whereby the identity of the buyer is verified by way of investigative review prior to the buyer being permitted to purchase the seller's goods. The invention also provides a system for matching a seller of goods with a buyer of goods who satisfies the seller's criteria.

According to one aspect of the present invention there is provided a method of matching a buyer of goods with a seller of goods comprising the following steps:

collecting information from the seller relating to the goods;

classifying the goods according to a pre-selected set of criteria selected by the seller, the pre-selected set of criteria including data relating to buyers that are to be denied access to the goods;

listing the goods in a secured manner;

collecting information relevant to said pre-selected set of criteria from the buyer;

verifying the information collected from the buyer;

selecting an approved buyer based on verified information;

authorizing the approved buyer to request a query of the listed goods for those goods that the buyer seeks to buy;

determining which goods are available for the approved buyer to buy based on a linkage between the approved buyer, the query and the pre-selected set of criteria.

According to another aspect of the present invention there is provided a method of matching a buyer of goods with a seller of goods comprising the following steps:

collecting information from the seller relating to the goods;

classifying the goods according to a pre-selected set of criteria selected by the seller, the pre-selected set of criteria including data relating to buyers that are to be denied access to the goods;

listing the goods in a secured manner;

collecting information relevant to said pre-selected set of criteria from the buyer;

verifying the information collected from the buyer;

selecting a rejected buyer based on verified information; and

forbidding a rejected buyer from accessing the listed goods.

According to another aspect of the present invention there is provided a system for matching a buyer of goods with a seller of goods comprising:

means for collecting information from the seller relating to the goods;

means for classifying the goods according to a pre-selected set of criteria selected by the seller, the pre-selected set of criteria including data relating to buyers that are to be denied access to the goods;

a database containing a listing of the goods in a secured manner;

means for collecting information relevant to said pre-selected set of criteria from the buyer;

means to verify the said buyer information;

means to select an approved buyer based on the verified buyer information;

an input means for permitting the approved buyer to query the database for goods that the approved buyer seeks to buy;

a data processor for determining which items of goods are available for the approved buyer to buy based on a linkage between the approved buyer, the query and the pre-selected set of criteria.

According to another aspect of the present invention there is provided a system for matching a buyer of goods with a seller of goods comprising:

means for collecting information from the seller relating to the goods;

means for classifying the goods according to a pre-selected set of criteria selected by the seller, the pre-selected set of criteria including data relating to buyers that are to be denied access to the goods;

a database containing a listing of the goods in a secured manner;

means for collecting information relevant to said pre-selected set of criteria from the buyer;

means to verify the said buyer information;

means to select a rejected buyer based on the verified buyer information; and

means to block the rejected buyer from accessing the listing of goods.

### BRIEF DESCRIPTION OF THE DRAWINGS

FIG. 1 is a flow chart showing a process for classifying of seller goods;

FIG. 2 is a flow chart showing a process for buyer and seller log on; and

FIG. 3 is a flow chart showing an approved buyer query process.

### DETAILED DESCRIPTION

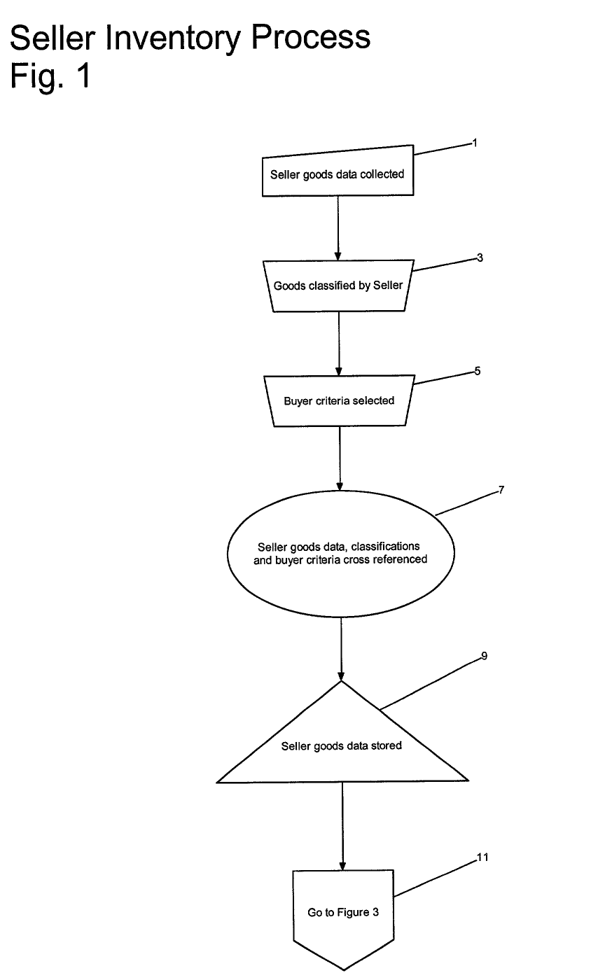

A preferred embodiment of a system for matching a seller's goods with appropriate buyers is implemented through three primary steps. These steps are shown in FIGS. 1-3 respectively.

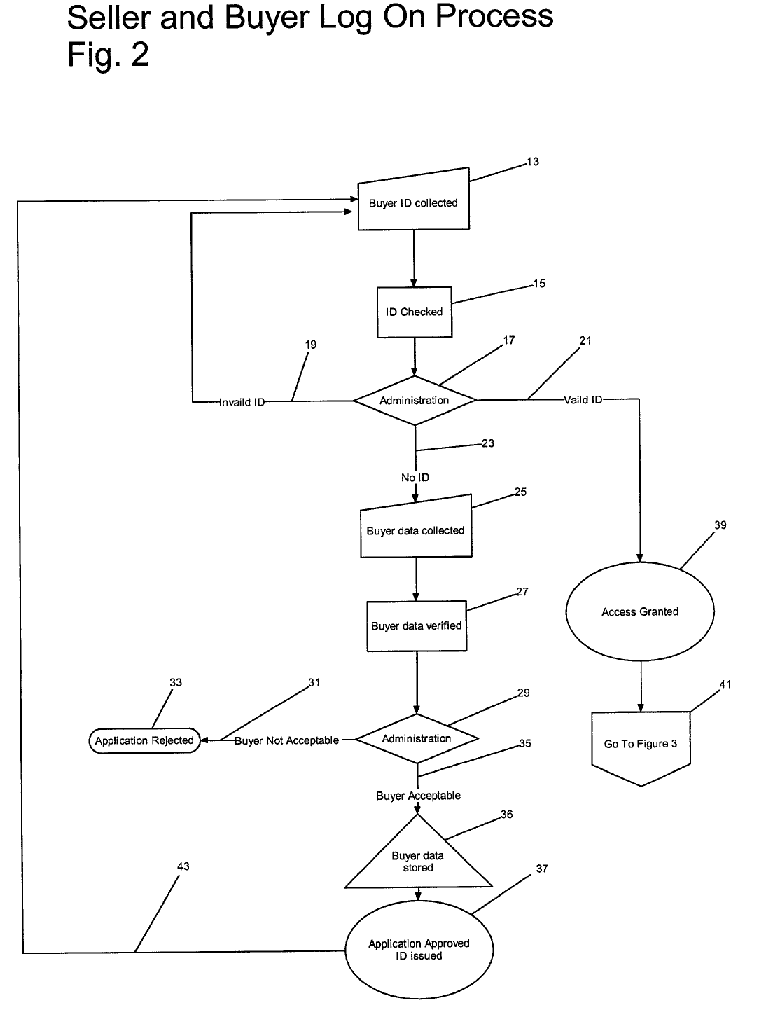

As shown in FIG. 1, sellers who wish to post their surplus goods for sale register on the system by way of a log on process shown in FIG. 2. Access to the system and log on process is by way of a data processing device connected to the internet. Access may also be by way of a private network such as an electronic data interchange or virtual private network. The sellers provide information relating to their identity such as their name, address and market segment. The system is described in further detail below. All information collected by the system from both sellers and buyers is stored by way of an electronic database accessible to the Internet.

Upon the conclusion of the registration process and system authorization, the sellers can list those goods on the system which they wish to sell 1. The listing of goods includes providing detailed information sufficient to enable potential buyers to make a purchase decision. The information relating to goods is collected from sellers by way of online forms through which the sellers input data applicable to the goods they wish to list. The online forms generally include input fields relating to an item title, description, quantity available for sale and goods specifications 3. The goods specifications generally includes the following: SKU; manufacturer name; goods brand name; country of origin; category and subcategory for the goods; acceptable payment methods; type of sale format; asking price (the price below which the seller will not sell the product); sale duration; regular wholesale price; the manufacturer's suggested retail price (MSRP); the pack, weight and dimension of the master carton, inner carton, and product itself and photograph of the listed items.

The listing of the goods includes the use of standardized classifications, such as pull down menus, to facilitate system queries from buyers. Such classifications include, for example, the categories: toys; apparel and cosmetics. After sellers have listed their goods, they may select buyer restrictions associated with the goods 5.

The system associates the sellers' buyer restrictions with the sellers' listed goods by way of a database. This is a key means by which sellers can block buyers from accessing the sellers goods listed on the system. The ability of sellers to block buyers reduces the problems of channel conflict. Sellers are able to select from a set of standardized classifications relating to all aspects of the information that the system has related to buyers pursuant to buyers information collected as set out in FIG. 2.

The types of criteria from which sellers may choose relating to buyers include the following: the type of company restricted from purchasing the goods; the particular type of retailer restricted from purchasing the goods; the type of buyer in a restricted goods industry; geographical region of business, classified by continent and then by constituent countries and, if applicable, constituent regions and the name of the buyer.

The type of company restricted from purchasing the goods generally includes the following: retailers; manufacturers; importers; exporters and wholesalers.

The particular type of retailer restricted from purchasing the goods generally includes the following: mass-market discounters; drug chains; supermarkets; specialty; gift; warehouse clubs; deep-discounters and general merchandiser.

The type of buyer in a restricted goods industry includes the following: apparel and jewelry; children and hobby; domestic chemicals; electronics; food and drinks; general merchandise; health and beauty care; household; publishing; seasonal; sports and fitness and stationary and office.

Sellers may choose different sets of criteria for each good they list on the system. For example, a seller's surplus hand soap may be available to company ABC whereas the seller's surplus dish detergent is not. Sellers may also choose to be anonymous, such that even buyers which satisfy the criteria associated with a seller's goods will not be provided with the identity of the seller.

Sellers inputted data relating to the their surplus goods, the classifications of such goods and the related buyer criteria are cross referenced within the system by way of an electronic database 7. The cross referencing permits the system to filter the listed goods in response to a buyer's queries. Without cross referencing, the system would not be able to effectively avoid channel conflict problems. Channel conflict results when retail and surplus goods buyers are selling the same good, to the same market, at the same time, but for different prices, retail and discount. Channel conflict creates significant problems for the seller of the goods at issue. Generally, the retail buyer demands to be reimbursed for the premium paid for the goods and as such the seller's profit margin is reduced. The data on the system is also stored in an indexed manner based on the cross references. As such, the data is searchable based on any piece of collected information related thereto.

The listed and cross referenced data is stored on the system in a secured manner such that only authorized buyers are granted access 9. The need to secure the data and limit access to it is critical for the success of the system. Sellers need to have confidence that their business decisions relating to the sale of their surplus goods is not available to any buyers which do not satisfy the sellers' criteria. The data can be secured by way of limited system access which requires buyers to be authorized for access as is shown in FIG. 2.

The system does not provide for the warehousing of the listed seller goods, it only stores the data related thereto and facilitates the matching of buyers and sellers.

As shown in FIG. 2, buyers wishing to enter the system must provide identification 13 issued by the system. The buyers access the system by way of a data processing device connected to the Internet. The identification provided by buyers will be checked against the record of authorized buyers 15 and only those buyers who have been approved 17 and have valid identification 21 will be granted access 39 to the system.

In the event that a buyer enters identification which, upon verification 15, the system determines to be invalid 19, the buyer will be permitted to repeat the log on process. If, however, the buyer does not have any system issued identification 23, the buyer will have to complete an application for system access.

To be authorized to access the system, buyers must provide information relating to the particulars and operational details about their organization 25. The information relating to the particulars and operational details is collected from the buyers by way of online forms through which the buyers input applicable data. The online forms generally include input fields relating to the following: contact name at buyer's; contact title; buyer's company name; trade classification; type of retailer; type of industry the buyer is involved with; geographical region of the buyer, classified by continent and then constituent counties and, if applicable, constituent regions; and the buyer billing and shipping address.

The trade classification generally includes the following: retailers; distributors; jobbers; manufacturers; importers; exporters and wholesalers.

The type of retailer goods generally includes the following: mass-market discounters; drug chains; supermarkets; specialty; gift; warehouse clubs; deep-discounters and general merchandisers.

The type of industry the buyer generally includes: apparel and jewelry; children and hobby; domestic chemicals; electronics; food and drinks; general merchandise; health and beauty care; household; publishing; seasonal; sports and fitness and stationary and office.

Many of the noted types of information are required to be provided. If the buyer fails to provide such information the system will not proceed to process the application.

Upon the completion and submission of the application, the system verifies the information provided by the buyer 27. The verification of the information is carried out by a manual, automatic or a combination thereof, review of the application. The review process may include the referencing of publicly available data, such as corporate registries, business compendiums, telephone listings and newspaper databases. If a more in-depth review is required, the process may include referencing privately available data. If further review is still required, the process may include the use of investigators to visit the site of the buyer or other such services as an investigator may offer to assist in the review of the application information.

The scope of the review will be based upon the extent to which the system operators determine the application information needs to be verified. If the system operators are not satisfied with the veracity of the information provided by the buyer 31 the application will be rejected 33 and the buyer will not be issued identification to access the system. Further, the system operators may verify the veracity of the application information but still reject the buyer application 33 if the system operators determine the buyer is a member a class of companies, or even a particular individual company, excluded from access to the system 31. Such companies may include international or market leading retailers and other such entities.

The verification of information provided by buyers is key to the commercial success of the system as it creates a secure environment for sellers to list their goods without fear of channel conflict.

To further increase the security of the system, the identification information provided by sellers may also be verified in a manner similar to the process for verifying information provided by buyers. The verification can occur prior to such sellers being authorized to access the system and list their goods.

In the event the buyer's application is verified and accepted 35, the buyer's information 36 will be stored on the system. The buyer is approved to access the system and is issued sufficient identification to facilitate such access 37. The identification usually consists of a user name and associated password. Upon the issuance of such identification, the buyer may log on 13 to the system 43.

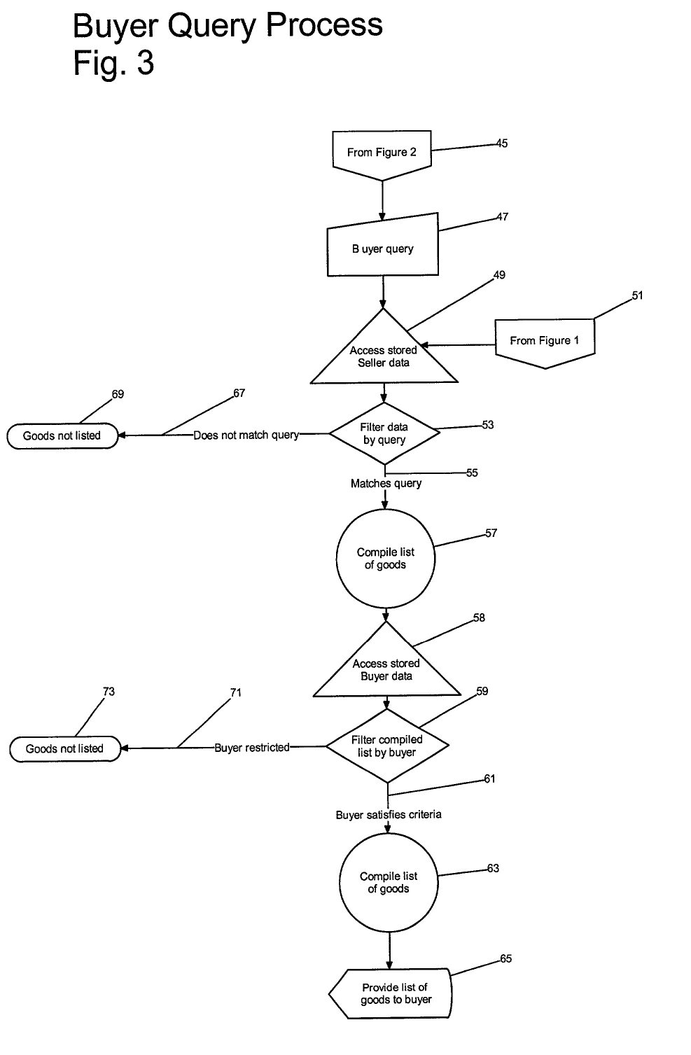

As shown in FIG. 3, upon the buyer successfully logging on to the system 39, the buyer may proceed to query the system for goods the buyer is interested in purchasing 47. The query process is by way of online forms through which the buyers are able to input query terms to search the system. The online forms generally include input query fields relating to the input fields used by the sellers to input data relating to their goods. The buyer's query usually consists of key words relating to the description of the type of goods the buyer wishes to search for. The key word query can be narrowed by way of limiting it to the various categories used by the seller to list the goods 3. Some of the key search categories include search by category, product location, product brand name, seller name, items posted since the user last visited our Web site or items that must be sold immediately. More advanced search categories include the following: required gross margin; discount from original retail price; discount from original wholesale price and quantity available.

In response to the query, the system accesses the data 49 provided by the various sellers 9. The system filters the inventory data by way of the electronic database 53. A list of those goods that match the query 55 is compiled by the system 57. Those goods that do not match 67, are not listed 69. The system then further filters the compiled list of goods 59 in accordance with the buyer restriction criteria 58 each seller has associated with its goods as set out at 5. The system compiles a list 63 of those goods wherein the querying buyer's data 36 satisfies the buyer criteria associated with the goods. The list is provided to the buyer 65. The buyer may then review the listed goods and has the option to purchase the goods directly from the seller by way of various methods of commerce, such as an ask and bid sale, open auction, sealed bid auction and other such means.

Although the invention has been described with preferred embodiments, it is to be understood that modifications may be resorted to as will be apparent to those skilled in the art. Such modifications and variations are to be considered within the purview and scope of the present invention.

1. A method of matching a buyer of goods with a seller of goods comprising the following steps:
collecting information from the seller relating to the goods;
classifying the goods according to a pre-selected set of criteria selected by the seller, the pre-selected set of criteria including data relating to buyers that are to be denied access to the goods;
listing the goods in a secured manner;
collecting information relevant to said pre-selected set of criteria from the buyer;
verifying the information collected from the buyer;
selecting an approved buyer based on verified information;
authorizing the approved buyer to request a query of the listed goods for those goods that the buyer seeks to buy;
determining which goods are available for the approved buyer to buy based on a linkage between the approved buyer, the query and the pre-selected set of criteria.

2. A method according to claim 1 wherein there is a plurality of sellers and buyers.

3. A method according to claim 1 wherein the approved buyer can purchase from the seller goods which are determined to be available.

4. A method according to claim 1 further including the following additional steps:
collecting information related to seller's identification;
verifying the information collected from the seller;
selecting an approved seller based on verified information; and
authorizing the approved seller to provide information relating to goods of the seller.

5. A method according to claim 1 wherein the verifying step comprises a means for manually confirming the buyer information by way of publicly available data.

6. A method according to claim 1 wherein the verifying step comprises a means for manually confirming the buyer information by way of privately held data.

7. A method according to claim 1 wherein the identity of the seller is not disclosed to the buyer.

8. A method of matching a buyer of goods with a seller of goods comprising the following steps:
collecting information from the seller relating to the goods;
classifying the goods according to a pre-selected set of criteria selected by the seller, the pre-selected set of criteria including data relating to buyers that are to be denied access to the goods;
listing the goods in a secured manner;
collecting information relevant to said pre-selected set of criteria from the buyer;
verifying the information collected from the buyer;
selecting a rejected buyer based on verified information; and
preventing a rejected buyer from accessing the listed goods.

9. A method according to claim 8 including a plurality of sellers and buyers.

10. A system for matching a buyer of goods with a seller of goods comprising:
means for collecting information from the seller relating to the goods;
means for classifyng the goods according to a pre-selected set of criteria selected by the seller, the pre-selected set of criteria including data relating to buyers that are to be denied access to the goods;
a database containing a listing of the goods in a secured manner;
means for collecting information relevant to said pre-selected set of criteria from the buyer;
means to verify the said buyer information;
means to select an approved buyer based on the verified buyer information;
an input means for permitting the approved buyer to query the database for goods that the approved buyer seeks to buy;
a data processor for determining which items of goods are available for the approved buyer to buy based on a linkage between the approved buyer, the query and the pre-selected set of criteria.

11. A system according to claim 10 including a plurality of sellers and buyers.

12. A system according to claim 10 further including:
means for collecting information related to seller's identification;
means for verifying the information collected from the seller;
means for selecting an approved seller based on verified information; and
means for authorizing the approved seller to provide information relating to goods of the seller.

13. A system according to claim 10 wherein the sellers and approved buyers access the system by way of a public communications network.

14. A system according to claim 10 wherein the sellers and approved buyers access the system by way of a private communications network.

15. A system according to claim 10 wherein the verification means comprises a processing means for automatically confirming the buyer information by way of publicly available data.

16. A system according to claim 10 wherein the verification means comprises a means for manually confirming the buyer information by way of publicly available data.

17. A system according to claim 10 wherein the verification means comprises a processing means for automatically confirming the buyer information by way of privately available data.

18. A system according to claim 10 wherein the verification means comprises a means for manually confirming the buyer information by way of privately available data.

19. A system for matching a buyer of goods with a seller of goods comprising:
means for collecting information from the seller relating to the goods;
means for classifying the goods according to a pre-selected set of criteria selected by the seller, the pre-selected set of criteria including data relating to buyers that are to be denied access to the goods;
a database containing a listing of the goods in a secured manner;
means for collecting information relevant to said pre-selected set of criteria from the buyer;
means to verify said buyer information;
means to select a rejected buyer based on the verified buyer information; and
means to prevent the rejected buyer from accessing the listing of goods.

20. A system according to claim 19 including a plurality of buyers and sellers.
